(19) United States
(12) Patent Application Publication
(10) Pub. No.: US 2008/0208674 A1
(43) Pub. Date: Aug. 28, 2008

(54) TARGETING ADVERTISING CONTENT IN A VIRTUAL UNIVERSE (VU)

(76) Inventors: Rick A. Hamilton, Charlottesville, VA (US); Brian M. O'Connell, Cary, NC (US); Clifford A. Pickover, Yorktown Heights, NY (US); Keith R. Walker, Austin, TX (US)

Correspondence Address: HOFFMAN WARNICK LLC, 75 STATE ST, 14TH FLOOR, ALBANY, NY, 12207, US

(21) Appl. No.: 11/679,485

(22) Filed: Feb. 27, 2007

(51) Int. Cl. G06F 17/30

(52) U.S. Cl. 705/10

(57) ABSTRACT

In general, the present invention allows advertising content to be targeted in a VU. Specifically, users' VU inventories that include visible assets are made available to an advertiser or other third party. This asset information is analyzed by the other party to determine the user's potential real world interests. Based on this analysis, the advertising content providers can target advertising content for real world goods and services.

### FIELD OF THE INVENTION

The present invention generally relates to computer-based or virtual universes. Specifically, the present invention provides an approach to target advertising content (e.g., consumer advertisements, social messages, etc.) in a virtual universe.

### BACKGROUND OF THE INVENTION

Virtual universes (VUs) are rapidly becoming a popular part of today's culture. In general, a VU is a digital world such as Second Life (Second Life is a trademark of Linden Research, Inc. in the United States and/or other countries), characterized by users controlling avatars representing the users as they interact with each other and the environment within the VU. An avatar is a graphical representation the user selects that others can see, often taking the form of a cartoon-like human or other figure. An agent is the user's account, upon which the user can build an avatar, and which is tied to the inventory of assets the user owns. A region is a virtual area of land within the VU, typically residing on a server's CPU. Assets, avatars, the environment, and anything visual comprise universally unique identifiers (UUIDs) tied to geometric data (distributed to users as textual coordinates), textures (distributed to users as graphics files), and effects data (rendered by the user's client according to the user's preferences and user's device capabilities).

Second Life and other on-line virtual environments present a tremendous new outlet for both structured and unstructured virtual collaboration, gaming and exploration, as well as real-life simulations in virtual spaces. These activities, along with yet to be disclosed new dimensions, in turn provide a wide open arena for creative and new advertising methods and mechanisms. Currently, an agent's inventory is disconnected from the user's real world interests and desires. As such, there is no existing approach that allows advertisers and the like to fully leverage the information and client base of the VUs. In view of the foregoing, there exists a need for a solution that solves this problem.

### SUMMARY OF THE INVENTION

In general, the present invention allows advertising content to be targeted in a VU. Specifically, users' VU inventories that include visible assets are made available to an advertiser or other third party. This asset information is analyzed by the other party to determine the user's potential real world interests. Based on this analysis, the advertising content providers can target advertising content for real world goods and services.

A first aspect of the invention provides a method for targeting advertising content in a virtual universe (VU), comprising: obtaining asset information pertaining to assets in an inventory of a user of the VU; analyzing the asset information to determine a set of real world interests of the user; and targeting advertising content to the user based on the set of real world interests.

A second aspect of the invention provides a system for targeting advertising content in a virtual universe (VU), comprising: a module for obtaining asset information pertaining to assets in an inventory of a user of the VU; a module for analyzing the asset information to determine a set of real world interests of the user; and a module for targeting advertising content to the user based on the set of real world interests.

A third aspect of the present invention provides a program product stored on a computer readable medium for targeting advertising content in a virtual universe (VU), the computer readable medium comprising program code for causing a computer system to: obtain asset information pertaining to assets in an inventory of a user of the VU; analyze the asset information to determine a set of real world interests of the user; and target advertising content to the user based on the set of real world interests.

A fourth aspect of the invention provides a method for providing a system for targeting advertising content in a virtual universe (VU), comprising: providing a computer infrastructure being operable to: obtain asset information pertaining to assets in an inventory of a user of the VU; analyze the asset information to determine a set of real world interests of the user; and target advertising content to the user based on the set of real world interests.

A fifth aspect of the invention provides computer software embodied in a propagated signal for targeting advertising content in a virtual universe (VU), the computer software comprising instructions for causing a computer system to: obtain asset information pertaining to assets in an inventory of a user of the VU; analyze the asset information to determine a set of real world interests of the user; and target advertising content to the user based on the set of real world interests.

A sixth aspect of the present invention provides a data processing system for targeting advertising content in a virtual universe (VU), comprising: a memory medium; a bus coupled to the memory medium; a processor coupled to the bus, the memory medium comprising instructions that when executed by the processor cause the data processing system to: obtain asset information pertaining to assets in an inventory of a user of the VU; analyze the asset information to determine a set of real world interests of the user; and target advertising content to the user based on the set of real world interests.

A seventh aspect of the invention provides a computer-implemented business method for targeting advertising content in a virtual universe (VU), comprising: obtaining asset information pertaining to assets in an inventory of a user of the VU; analyzing the asset information to determine a set of real world interests of the user; and targeting advertising content to the user based on the set of real world interests.

Each of these aspects can also incorporate one or more of the following additional aspects: the asset information being obtained by receiving a feed containing the asset information from a provider VU; the feed being based on a query of the assets against a database associated with the VU; the asset information being obtained and recorded pursuant to a script being executed by users of the VU against one another; the asset information comprising a universally unique identifier associated with the use, and an inventory of the assets; the asset information being limited to visible assets in the inventory; the analyzing comprising: creating an interest profile for the user based on other users of the VU who possess similar assets, comparing the interest profile to interest profiles of the other users, and classifying the user based on the comparing; the analyzing comprising at least one of the following: examining information tags associated with the assets, examining hyperlinks associated with the assets, and examining contact information of the user; and/or the targeting comprising at least one of the following: scripting interaction with the user within the VU to deliver the advertising content, placing the advertising content in an environment of the user within the VU, and sending the advertising content to the user external to the VU.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts an illustrative computer system for implementing the teachings of the present invention.

FIG. 2 depicts an illustrative virtual environment according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

In general, present invention allows advertising content to be targeted in a VU. Specifically, users' VU inventories that include visible assets are made available to an advertiser or other third party. This asset information is analyzed by the other party to determine the user's potential real world interests. Based on this analysis, the advertising content providers can target advertising content for real world goods and services.

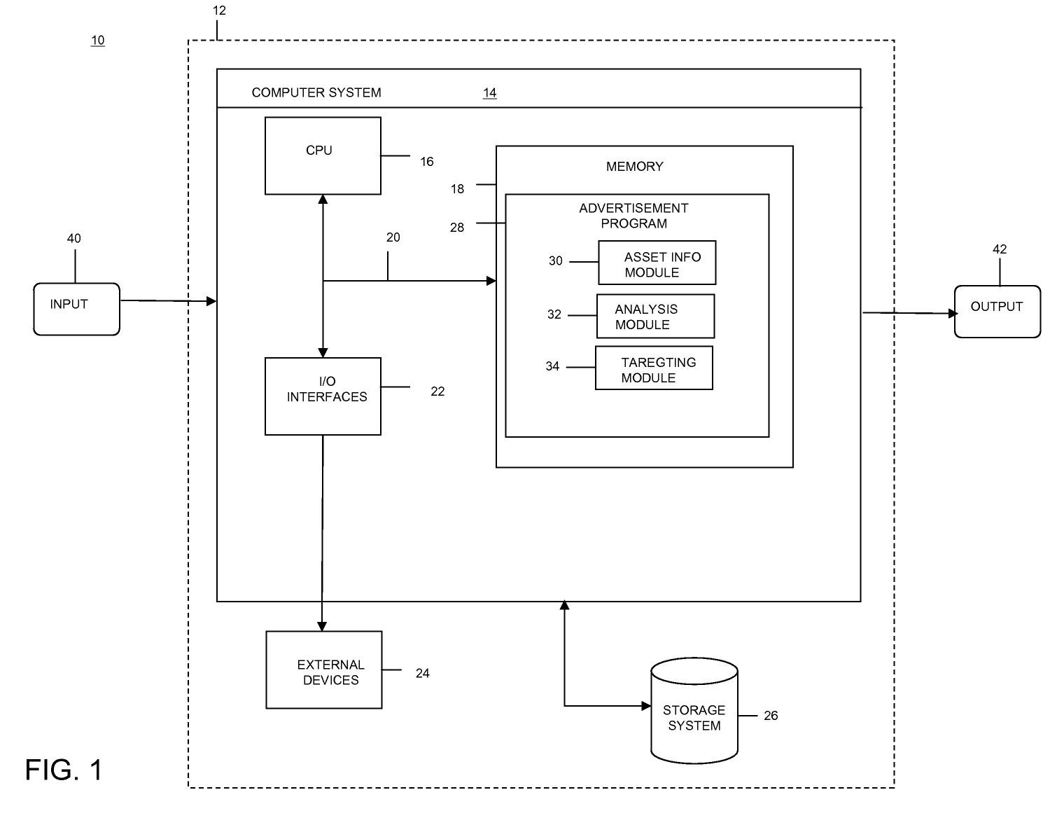

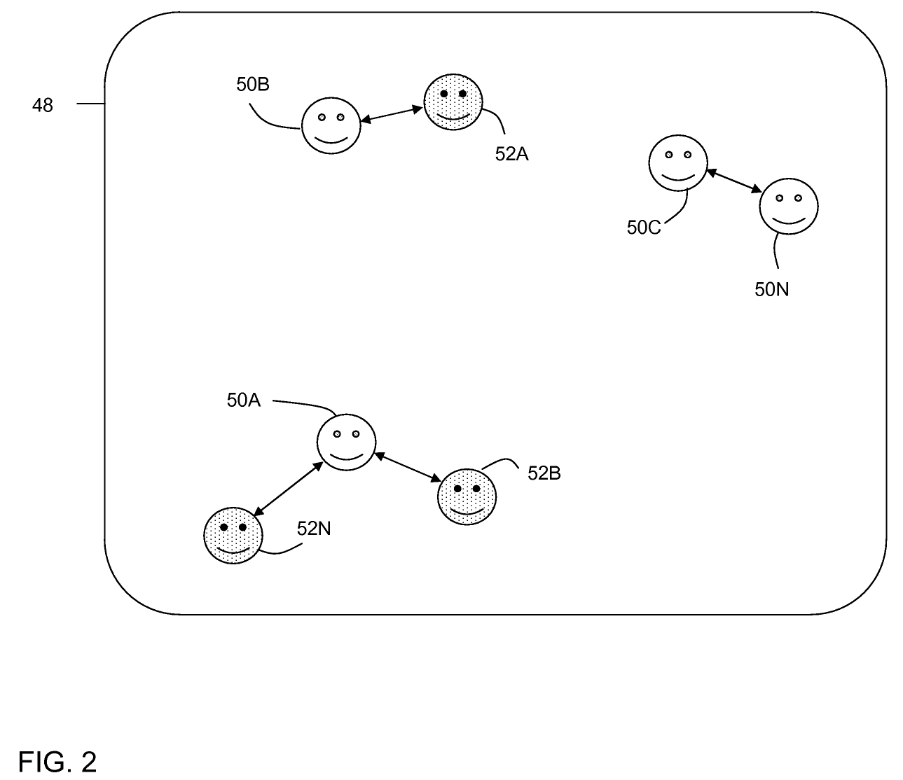

These concepts will be explained in greater detail with respect to FIGS. 1 and 2 collectively. Specifically, FIG. 1 shows a computerized implementation 10 of the present invention to be further described below, while FIG. 2 shows an illustrative VU 48 having user-based avatars 50A-N, and advertisement-based avatars 52A-D. As mentioned above, user-based avatars 50A-N are graphical representations of users that have characteristics (physical and otherwise) based on selections and/or designations made in the users' accounts. Avatars 50A-N navigate about VU 48 and interact with each other and the environment of VU 48.

As depicted in FIG. 1, implementation 10 includes computer system 14 deployed within a computer infrastructure 12. This is intended to demonstrate, among other things, that the present invention could be implemented within a network environment (e.g., the Internet, a wide area network (WAN), a local area network (LAN), a virtual private network (VPN), etc.), or on a stand-alone computer system. In the case of the former, communication throughout the network can occur via any combination of various types of communications links. For example, the communication links can comprise addressable connections that may utilize any combination of wired and/or wireless transmission methods. Where communications occur via the Internet, connectivity could be provided by conventional TCP/IP sockets—based protocol, and an Internet service provider could be used to establish connectivity to the Internet. Still yet, computer infrastructure 12 is intended to demonstrate that some or all of the components of implementation 10 could be deployed, managed, serviced, etc. by a service provider who offers to implement, deploy, and/or perform the functions of the present invention for others. Along these lines, any component shown in FIG. 1 could be implemented by a provider of VU 48, an advertiser, or other third party. In any event, advertisement program 28 can work in conjunction with any program(s) used to provide and/or manage VU 48.

As shown, computer system 14 includes a processing unit 16, a memory 18, a bus 20, and input/output (I/O) interfaces 22. Further, computer system 14 is shown in communication with external I/O devices/resources 24 and storage system 26. In general, processing unit 16 executes computer program code, such as advertisement program 28, which is stored in memory 18 and/or storage system 26. While executing computer program code, processing unit 16 can read and/or write data to/from memory 18, storage system 26, and/or I/O interfaces 22. Bus 20 provides a communication link between each of the components in computer system 14. External devices 24 can comprise any devices (e.g., keyboard, pointing device, display, etc.) that enable a user to interact with computer system 14 and/or any devices (e.g., network card, modem, etc.) that enable computer system 14 to communicate with one or more other computing devices.

Computer infrastructure 12 is only illustrative of various types of computer infrastructures for implementing the invention. For example, in one embodiment, computer infrastructure 12 comprises two or more computing devices (e.g., a server cluster) that communicate over a network to perform the process(es) of the invention. Moreover, computer system 14 is only representative of various possible computer systems that can include numerous combinations of hardware. To this extent, in other embodiments, computer system 14 can comprise any specific purpose computing article of manufacture comprising hardware and/or computer program code for performing specific functions, any computing article of manufacture that comprises a combination of specific purpose and general purpose hardware/software, or the like. In each case, the program code and hardware can be created using standard programming and engineering techniques, respectively. Moreover, processing unit 16 may comprise a single processing unit, or be distributed across one or more processing units in one or more locations, e.g., on a client and server. Similarly, memory 18 and/or storage system 26 can comprise any combination of various types of data storage and/or transmission media that reside at one or more physical locations. Further, I/O interfaces 22 can comprise any system for exchanging information with one or more external device 24. Still further, it is understood that one or more additional components (e.g., system software, math co-processing unit, etc.) not shown in FIG. 1 can be included in computer system 14. However, if computer system 14 comprises a handheld device or the like, it is understood that one or more external devices 24 (e.g., a display) and/or storage system 26 could be contained within computer system 14, not externally as shown.

Storage system 26 can be any type of system (e.g., a database) capable of providing storage for information under the present invention. To this extent, storage system 26 could include one or more storage devices, such as a magnetic disk drive or an optical disk drive. In another embodiment, storage system 26 includes data distributed across, for example, a local area network (LAN), wide area network (WAN) or a storage area network (SAN) (not shown). In addition, although not shown, additional components, such as cache memory, communication systems, system software, etc., may be incorporated into computer system 14.

Shown in memory 18 of computer system 14 is advertisement program 28, which facilitates the functions as described herein. As depicted, advertisement program 28 includes asset information module 30, analysis module 32, and targeting module 34. It should be understood that this configuration of functionality is intended to be illustrative only, and that identical or similar functionality could be provided with a different configuration of systems. In any event, advertisement program 28 allows advertising content to be targeted to avatars 50A-N based on real world interests of the associated users. Specifically, asset information module 30 will first obtain asset information as input 40 pertaining to any assets that may be present in an inventory of a user of VU 48. Along these lines, each user's account 50A-N has an associated inventory of items or assets that their corresponding avatar has accumulated within VU 48. In general, there are at least two alternative embodiments for this step. In a first embodiment, input 40 may comprise a database feed from a provider of VU 48, which is a query of the assets in the VU's database and contains a subset of data required by the advertiser. In a second embodiment, advertisers or other parties can write own scripts, executed by an in-universe avatar 50A-N upon another avatar 50A-N, which record any asset information available and store it into a database (e.g., of the party writing the script).

In both embodiments, the following data is collected and stored in a database as asset information: (1) UUIDs associated with the users/avatar 50A-N; and (2) all visible assets mapped to those UUIDs. By “visible” we typically mean assets that can be discovered and are not flagged for hiding. For privacy, a user may opt to hide assets from data collection, and an administrator or the advertiser may flag certain types of assets as irrelevant. The asset data includes asset UUID, asset names, asset types, any information tags, and any links to external sites.

Once obtained, the asset information is then analyzed by analysis module 32 to determine real word interests of the users. In a typical embodiment, the data is mined/analyzed as follows:
(1) An interest profile of the user is created based on other users who own similar assets, discovered by the asset type. For example, if someone owns a plurality of virtual books, they will be considered more likely to be interested in real world books than a user who lacks books in their inventory. Similarly, any virtual book titles discovered by either an information tag or by applying Optical Character Recognition (OCR) upon the texture of the book, can be used to further narrow in on a user's interests. Another example is digital music purchased from a service that can be broadcast in the VU 48 (the audio component of the song being a non-geometrical asset, with option to have geometric and texture information such as in the form of an album cover).
(2) If the user has purchased or been given a virtual asset by an outside entity such as a retailer, the following steps can be applied to gain further information about the user:
   (A) If there is an information tag that includes the real world manufacturer and part number, this can be looked up to determine the product.
   (B) If there is a link associated with the asset to an external site, the page can be downloaded and queried for company (based on URL) and product type (based on scraping the page for product type).
   (C) If there is a data feed to the company that supplied the virtual asset, the UUID can be a key field to discover where the real world transaction was made, when it was made, the user's real contact information (location, billing history, etc.), and any other information the company has collected.

By mining the items in a user's inventory, various kinds of demographic information might be inferred, such as gender, interests, spending habits (willingness to spend), and age.

Once the profile of the user is determined in the previous steps, targeting module 34 can then match the products and services that most resemble the user's profile and real world interests, and then do any of the following to target the user with the advertisement (shown as output 42):
(1) Script an advertiser avatar 52A-N to walk up to the user-based avatars 50A-N and deliver an audio, video, or text chat message with the advertisement, or wear a billboard or hold a sign with the advertisement.
(2) Place billboards and other signage in the environment of the users' avatar 50A-N.
(3) If a link to the user's real world contact devices is known (email, instant messaging, telephone, fax, etc.), an advertisement may be sent there.

As indicated above, the present invention also allows for user control. That is, the users can be given the option to open or close their inventory for targeting by any one of the following ways:
(1) Keep their inventory completely closed (i.e., no targeted advertising can occur).
(2) Open portions of their inventory (i.e., sections which can be used for targeted ads, e.g., I would like to receive a real-world coupon for something my avatar carries) while keeping other portions closed.
(3) Open portions of their inventory to selected entities, either only in certain universes, or to advertisers with certain product criteria. This functionality can be provided/enabled by any of the modules shown in FIG. 1, or by a module within software used to implement and manage VU 48. A reward structure can be also put in place by advertisers or by services representing groups of advertisers to encourage opening inventory.

While shown and described herein as a method and system for targeting advertising content in a VU, it is understood that the invention further provides various alternative embodiments. For example, in one embodiment, the invention provides a computer-readable/useable medium that includes computer program code to enable a computer infrastructure to target advertising content in a VU. To this extent, the computer-readable/useable medium includes program code that implements the process(es) of the invention. It is understood that the terms computer-readable medium or computer useable medium comprises one or more of any type of physical embodiment of the program code. In particular, the computer-readable/useable medium can comprise program code embodied on one or more portable storage articles of manufacture (e.g., a compact disc, a magnetic disk, a tape, etc.), on one or more data storage portions of a computing device, such as memory 18 (FIG. 1) and/or storage system 26 (FIG. 1) (e.g., a fixed disk, a read-only memory, a random access memory, a cache memory, etc.), and/or as a data signal (e.g., a propagated signal) traveling over a network (e.g., during a wired/wireless electronic distribution of the program code).

In another embodiment, the invention provides a business method that performs the process of the invention on a subscription, advertising, and/or fee basis. That is, a service provider, such as a Solution Integrator, could offer to target advertising content in a VU. In this case, the service provider can create, maintain, support, etc., a computer infrastructure, such as computer infrastructure 12 (FIG. 1) that performs the process of the invention for one or more customers. In return, the service provider can receive payment from the customer(s) under a subscription and/or fee agreement and/or the service provider can receive payment from the sale of advertising content to one or more third parties.

In still another embodiment, the invention provides a computer-implemented method for targeting advertising content in a VU. In this case, a computer infrastructure, such as computer infrastructure 12 (FIG. 1), can be provided and one or more systems for performing the process of the invention can be obtained (e.g., created, purchased, used, modified, etc.) and deployed to the computer infrastructure. To this extent, the deployment of a system can comprise one or more of: (1) installing program code on a computing device, such as computer system 14 (FIG. 1), from a computer-readable medium; (2) adding one or more computing devices to the computer infrastructure; and (3) incorporating and/or modifying one or more existing systems of the computer infrastructure to enable the computer infrastructure to perform the process of the invention.

As used herein, it is understood that the terms “program code” and “computer program code” are synonymous and mean any expression, in any language, code or notation, of a set of instructions intended to cause a computing device having an information processing capability to perform a particular function either directly or after either or both of the following: (a) conversion to another language, code or notation; and/or (b) reproduction in a different material form. To this extent, program code can be embodied as one or more of: an application/software program, component software/a library of functions, an operating system, a basic I/O system/driver for a particular computing and/or I/O device, and the like.

A data processing system suitable for storing and/or executing program code can be provided hereunder and can include at least one processor communicatively coupled, directly or indirectly, to memory element(s) through a system bus. The memory elements can include, but are not limited to, local memory employed during actual execution of the program code, bulk storage, and cache memories that provide temporary storage of at least some program code in order to reduce the number of times code must be retrieved from bulk storage during execution. Input/output or I/O devices (including, but not limited to, keyboards, displays, pointing devices, etc.) can be coupled to the system either directly or through intervening I/O controllers.

Network adapters also may be coupled to the system to enable the data processing system to become coupled to other data processing systems, remote printers, storage devices, and/or the like, through any combination of intervening private or public networks. Illustrative network adapters include, but are not limited to, modems, cable modems and Ethernet cards.

The foregoing description of various aspects of the invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of the invention as defined by the accompanying claims.

We claim:

1. A method for targeting advertising content in a virtual universe (VU), comprising:
obtaining asset information pertaining to assets in an inventory of a user of the VU;
analyzing the asset information to determine a set of real world interests of the user; and
targeting advertising content to the user based on the set of real world interests.

2. The method of claim 1, the obtaining comprising receiving a feed containing the asset information from a provider VU.

3. The method of claim 2, the feed being based on a query of the assets against a database associated with the VU.

4. The method of claim 1, the obtaining comprising obtaining and recording the asset information pursuant to a script being executed by users of the VU against one another.

5. The method of claim 1, the asset information comprising:
a universally unique identifier associated with the user; and
an inventory of the assets.

6. The method of claim 1, the obtaining being limited to visible assets in the inventory.

7. The method of claim 1, further comprising providing the user with a user control level, the user control level comprising at least one of the following:
keeping the inventory completely closed;
opening a portion of the inventory; and
opening a portion of the inventory based on selected criteria.

8. The method of claim 1, the analyzing comprising;
creating an interest profile for the user based on other users of the VU who possess similar assets;
comparing the interest profile to interest profiles of the other users; and
classifying the user based on the comparing.

9. The method of 1, the analyzing comprising at least one of the following:
examining information tags associated with the assets;
examining hyperlinks associated with the assets; and
examining contact information of the user.

10. The method of claim 1, the targeting comprising at least one of the following:
scripting interaction with the user within the VU to deliver the advertising content;
placing the advertising content in an environment of the user within the VU; and
sending the advertising content to the user external to the VU.

11. A system for targeting advertising content in a virtual universe (VU), comprising:
a module for obtaining asset information pertaining to assets in an inventory of a user of the VU;
a module for analyzing the asset information to determine a set of real world interests of the user; and
a module for targeting advertising content to the user based on the set of real world interests.

12. The system of claim 11, the module for obtaining being configured to receive a feed containing the asset information from a provider VU.

13. The system of claim 12, the feed being based on a query of the assets against a database associated with the VU.

14. The system of claim 11, the module for obtaining being configured to obtain and record the asset information pursuant to a script being executed by users of the VU against one another.

15. The system of claim 11, the asset information comprising:
a universally unique identifier associated with the user; and
an inventory of the assets.

16. The system of claim 11, the module for obtaining being configured to obtain only visible assets in the inventory.

17. The system of claim 11, the module for analyzing being configured to:
create an interest profile for the user based on other users of the VU who possess similar assets;
compare the interest profile to interest profiles of the other users; and
classify the user based on the comparing.

18. The system of 11, the module for analyzing being configured to perform at least one of the following:
examine information tags associated with the assets;
examine hyperlinks associated with the assets; and
examine contact information of the user.

19. The system of claim 11, the module for targeting being configured to perform at least one of the following:
scripting interaction with the user within the VU to deliver the advertising content;
placing the advertising content in an environment of the user within the VU; and
sending the advertising content to the user external to the VU.

20. A program product stored on a computer readable medium for targeting advertising content in a virtual universe (VU), the computer readable medium comprising program code for causing a computer system to:
obtain asset information pertaining to assets in an inventory of a user of the VU;
analyze the asset information to determine a set of real world interests of the user; and
target advertising content to the user based on the set of real world interests.

21. The program product of claim 20, the computer readable medium comprising further program code for causing the computer system to receive a feed containing the asset information from a provider VU.

22. The program product of claim 21, the feed being based on a query of the assets against a database associated with the VU.

23. The program product of claim 20, the computer readable medium comprising further program code for causing the computer system to obtain and record the asset information pursuant to a script being executed by users of the VU against one another.

24. The program product of claim 20, the asset information comprising:
a universally unique identifier associated with the user; and
an inventory of the assets.

25. The program product of claim 20, the asset information being limited to visible assets in the inventory.

26. The program product of claim 20, the computer readable medium comprising further program code for causing the computer system to:
create an interest profile for the user based on other users of the VU who possess similar assets;
compare the interest profile to interest profiles of the other users; and
classify the user based on the comparing.

27. The program product of 20, the computer readable medium comprising further program code for causing the computer system to perform at least one of the following:
examine information tags associated with the assets;
examine hyperlinks associated with the assets; and
examine contact information of the user.

28. The program product of claim 20, the computer readable medium comprising further program code for causing the computer system to perform at least one of the following:
script interaction with the user within the VU to deliver the advertising content;
place the advertising content in an environment of the user within the VU; and
send the advertising content to the user external to the VU.

29. A method for deploying a system for targeting advertising content in a virtual universe (VU), comprising:
providing a computer infrastructure being operable to:
obtain asset information pertaining to assets in an inventory of a user of the VU;
analyze the asset information to determine a set of real world interests of the user; and
target advertising content to the user based on the set of real world interests.
